(19) United States
(12) Patent Application Publication
(10) Pub. No.: US 2025/0334846 A1
(43) Pub. Date: Oct. 30, 2025

(54) VEHICULAR VISOR ATTACHMENT ASSEMBLY

(71) Applicant: Gentex Corporation, Zeeland, MI (US)

(72) Inventors: Eric S. Lundy, Holland, MI (US); Richard A. Berry, Zeeland, MI (US); Danny L. Minikey, JR., Fenwick, MI (US)

(21) Appl. No.: 19/188,304

(22) Filed: Apr. 24, 2025

Related U.S. Application Data
(60) Provisional application No. 63/639,906, filed on Apr. 29, 2024.

(51) Int. Cl. G02F 1/153; B60J 3/02; B60J 3/04; G02F 1/163

(52) U.S. Cl. CPC G02F 1/1533; B60J 3/026; B60J 3/0278; B60J 3/04; G02F 1/163

(57) ABSTRACT

An automotive visor includes a visor body including a first articulation surface and a first magnetic element disposed within the articulation surface and a mounting block configured to attach to a vehicle along a portion of a headliner. The mounting block defines a second articulation surface and includes a second magnetic element disposed adjacent to the second articulation surface. The first and second magnetic elements are mutually attracted to each other to maintain an articulating contact between the first articulation surface and the second articulation surface under a force applied to the visor body below a breakaway threshold.

### CROSS-REFERENCE TO RELATED APPLICATION

This application claims priority to and the benefit under 35 U.S.C. § 119(e) of U.S. Provisional Application No. 63/639,906, filed on Apr. 29, 2024, entitled “VEHICULAR VISOR ATTACHMENT ASSEMBLY,” the disclosure of which is hereby incorporated herein by reference in its entirety.

### BACKGROUND

The present disclosure relates generally to an automotive visor and more particularly, relates to automotive visor attachment assembly with a magnetic mounting block.

Automotive visors are used to selectively shield the eyes of an occupant from sun, while maintaining a generally acceptable field of view, particularly for the driver. In some known implementations, such visors can be a generally opaque body that is relatively thin and planar, while being configured to extend along a portion of the vehicle headliner. They are rotatable between a stowed position, wherein the visor body is disposed against the headliner and a range of use positions, where the body is angled relative to the headliner and extends over a portion of the windshield relative to the field of view of the occupant. Additionally, an inside edge of some visors are releasable so that the visor can be rotated outwardly against a side window Typically, such release is facilitated by retention of a corner of the visor using aplastic clip secured to the headliner. Such clips may be susceptible to breaking and may be limiting in the direction in which the visor must be moved to effect a release of the corresponding side of the visor.

### SUMMARY

According to one aspect of the present disclosure, an automotive visor includes a visor body including a first articulation surface and a first magnetic element disposed within the articulation surface and a mounting block configured to attach to a vehicle along a portion of a headliner. The mounting block defines a second articulation surface and includes a second magnetic element disposed adjacent to the second articulation surface. The first and second magnetic elements are mutually attracted to each other to maintain an articulating contact between the first articulation surface and the second articulation surface under a force applied to the visor body below a breakaway threshold.

According to another aspect of the disclosure, an automotive visor includes a visor body having a first articulation surface and a first magnetic element disposed within the articulation surface and a mounting block configured to attach to a vehicle along a portion of a headliner. The mounting block defines a second articulation surface, a leading edge, and a trailing edge. The leading edge is positionable closer to a vehicle windshield than the trailing edge and is positioned vertically below the trailing edge. The mounting block further includes a second magnetic element disposed adjacent to the second articulation surface. The first and second magnetic elements are mutually attracted to each other to maintain an articulating contact between the first articulation surface and the second articulation surface under a force applied to the visor body below a breakaway threshold that varies with a direction of the force applied to the visor body. The breakaway threshold corresponding with an impact force on the visor body directed horizontally toward the windshield is greater than the breakaway force corresponding with a deployment force directed horizontally away from the windshield.

According to another aspect of the disclosure, an automotive visor system for a vehicle having a windshield includes a visor body having a first articulation surface and a first magnetic element disposed within the articulation surface and a mounting block configured to attach to a vehicle along a portion of a headliner. The mounting block defines a second articulation surface and has a second magnetic element disposed adjacent to the second articulation surface. The first and second magnetic elements are mutually attracted to each other to maintain an articulating contact between the first articulation surface and the second articulation surface under a force applied to the visor body below a breakaway threshold. The breakaway threshold is configured to maintain the first articulating surface in contact with the second articulating surface during rotation of the visor body between a deployed position and at least one of a plurality of use positions. The visor system further includes a position sensor mounted within the visor body and detecting a magnetic field associated with the second magnetic element, an electrochromic element configurable between a plurality of transmissiveness states responsive to a voltage application, and a controller configured for applying the voltage to the electrochromic element and being in communication with the position sensor. The controller uses position information from the position sensor to control at least one operational characteristic of the electrochromic element, including the state of transmissiveness.

These and other features, advantages, and objects of the present device will be further understood and appreciated by those skilled in the art upon studying the following specification, claims, and appended drawings.

### BRIEF DESCRIPTION OF THE DRAWINGS

The present invention will become more fully understood from the detailed description and the accompanying drawings, wherein:

FIG. 1 is a front perspective view of an automotive visor assembly according to an aspect of the disclosure;

FIG. 2 is a rear perspective view of the automotive visor assembly;

FIG. 3 is a perspective detail view of the portion of the automotive visor assembly indicated in FIG. 1;

FIG. 4 is a perspective detail view of the portion of the automotive visor assembly indicated in FIG. 2;

FIG. 5 is a side perspective view of the automotive visor of FIG. 1 with a visor body thereof moved from a deployed position to a stowed position;

FIG. 6 is a front perspective view of the automotive visor with the visor body detached from a mounting block thereof and moved to an outwardly-rotated position;

FIG. 7 is a detail cross section view of a portion of the automotive visor assembly including a mounting block thereof;

FIG. 8 is a detail cross section view of the portion of the automotive visor assembly with the visor body rotated relative to the mounting block;

FIG. 9 is a schematic view showing aspects of the geometry of the portions of the visor assembly affecting various breakover thresholds associated therewith;

FIG. 10 is a graph showing variations in breakover thresholds for the visor assembly with respect to the geometry illustrated in FIG. 9;

FIG. 11 is a rear perspective view of the portion of the automotive visor assembly with the visor body detached from the mounting block and rotated in a direction toward a windshield of the vehicle; and

FIG. 12 is a perspective detail view showing a portion of the automotive visor assembly in the position of FIG. 11.

### DETAILED DESCRIPTION OF EMBODIMENTS

The present illustrated embodiments reside primarily in combinations of method steps and apparatus components related to an automotive visor assembly. Accordingly, the apparatus components have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

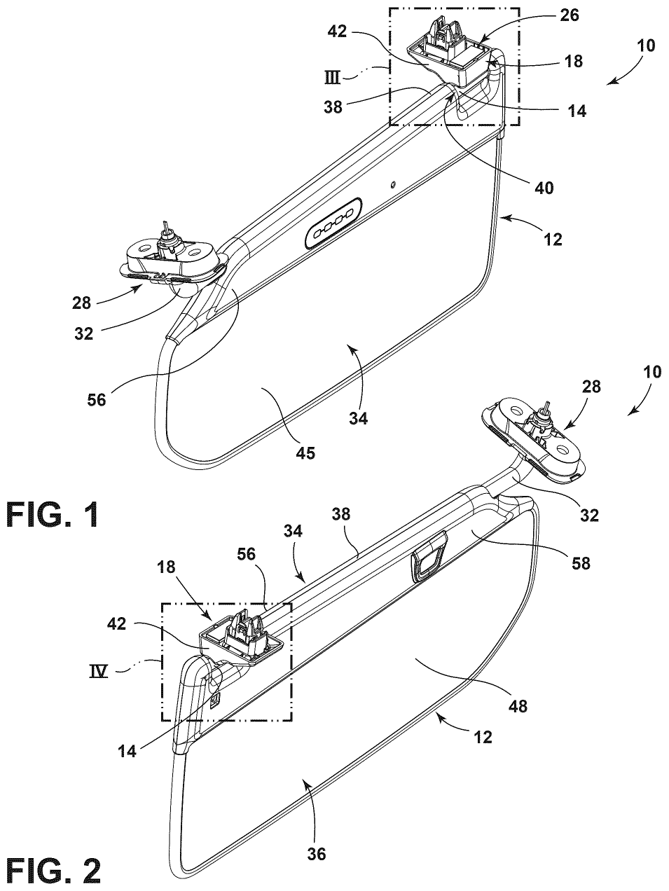

For purposes of description herein the terms “upper,” “lower,” “right,” “left,” “rear,” “front,” “vertical,” “horizontal,” and derivatives thereof shall relate to the device as oriented in FIG. 1. However, it is to be understood that the device may assume various alternative orientations and step sequences, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

Ordinal modifiers (i.e., “first”, “second”, etc.) may be used to distinguish between various structures of the disclosed automotive visor assembly in various contexts, but that such ordinals are not necessarily intended to apply to such elements outside of the particular context in which they are used and that, in various aspects different ones of the same class of elements may be identified with the same, context-specific ordinal. In such instances, other particular designations of the elements are used to clarify the overall relationship between such elements. Ordinals are not used to designate a position of the elements, nor do they exclude additional, or intervening, non-ordered elements or signify an importance or rank of the elements within a particular class.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a . . . ” does not, without more constraints, preclude the existence of additional identical elements in the process, method, article, or apparatus that comprises the element.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

For purposes of this disclosure, the terms “about”, “approximately”, or “substantially” are intended to mean that a value of a parameter is close to a stated value or position. However, minor differences may prevent the values or positions from being exactly as stated. Thus, unless otherwise noted, differences of up to ten percent (10%) for a given value are reasonable differences from the ideal goal of exactly as described. In many instances, a significant difference can be when the difference is greater than ten percent (10%), except as where would be generally understood otherwise by a person of ordinary skill in the art based on the context in which such term is used.

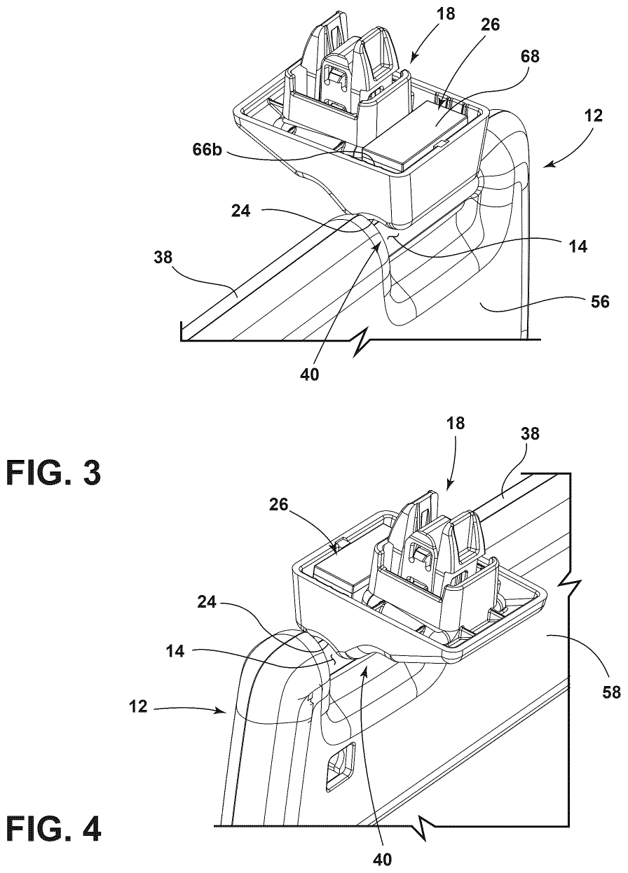

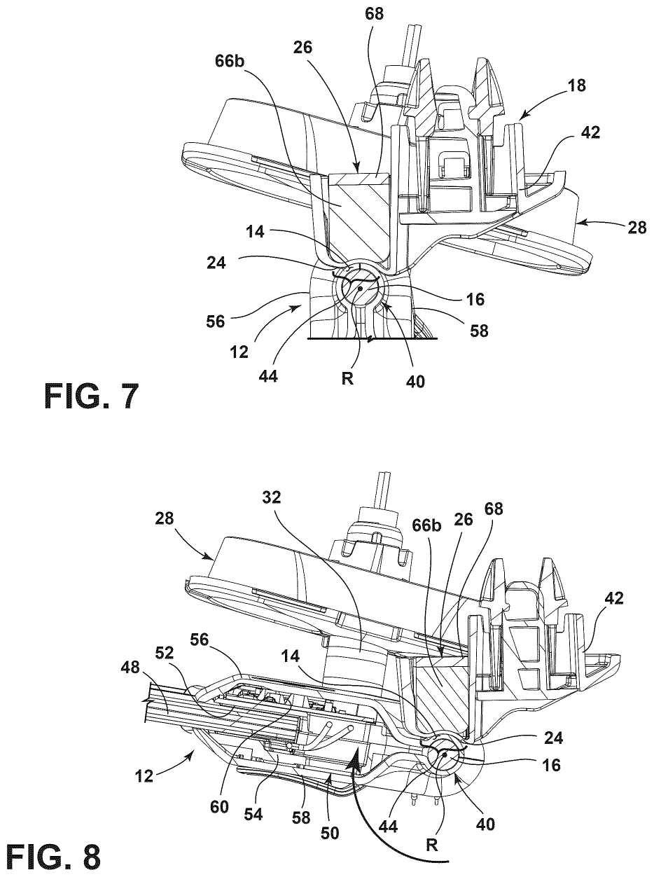

Referring to FIGS. 1-10, reference numeral 10 generally designates an automotive visor assembly. The automotive visor assembly 10 includes a visor body 12 including a first articulation surface 14 and a first magnetic element 16 (FIG. 7) disposed on an interior of the articulation surface 14 and a mounting block 18 configured to attach to a vehicle 20 along a portion of a headliner 22. The mounting block 18 defines a second articulation surface 24 and includes a second magnetic element 26 disposed adjacent to the second articulation surface 24. The first and second magnet elements 16, 26 are mutually attracted to each other to maintain an articulating contact between the first articulation surface 14 and the second articulation surface 24 under a load below a breakaway threshold.

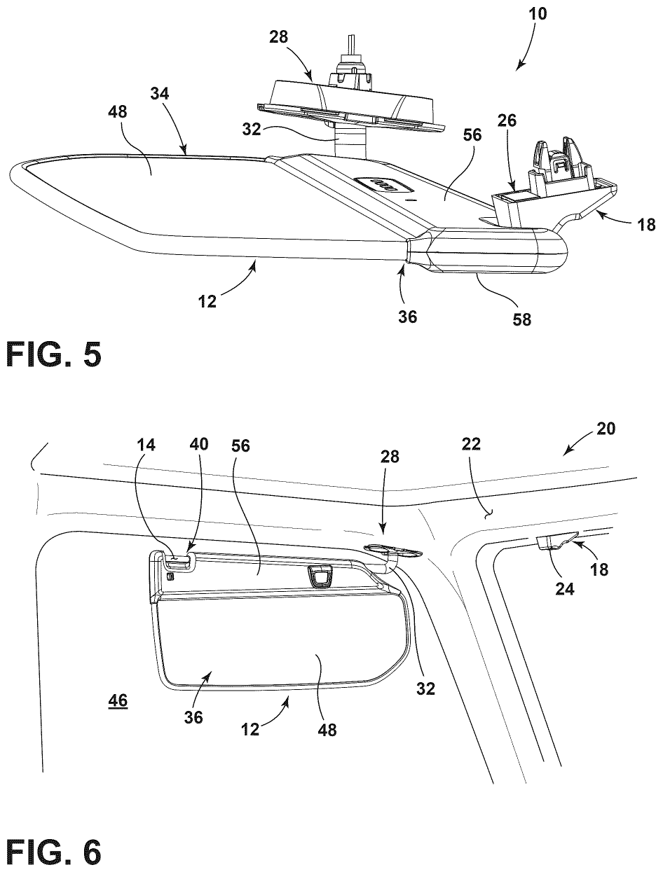

Referring generally to FIGS. 1-6, the visor assembly 10 includes the above-mentioned mounting block 18 along with a pivot mount 28 generally disposed on opposite lateral side of the visor body 12 and configured to allow the visor body 12 to rotate from a stowed position (FIG. 5), wherein the visor body 12 is disposed against the headliner 22 of the vehicle 20, and a range of use positions, including but not limited to the deployed position shown in FIGS. 1-4, wherein the visor body 12 is rotated downwardly from the headliner 22 to at least partially extend into the user's field of vision. In at least one aspect, the range of motion of the visor body 12 about the mounting block 18 and the pivot mount 28 is defined between the headliner 22 and a portion of the windshield 30 that may be contacted by a lower edge 39 of the visor body 12, when rotated downward and outward toward the windshield 30 in a manner typical of automotive visors in general. In this manner, the visor is moveable to, for example, shade the user's eyes from direct sunlight visible through the upper portion of the windshield 30. As mentioned above, the mutual attraction between the first magnetic element 16 and the second magnetic element 26 is configured to be sufficient to maintain engagement of the first articulation surface 14 and the second articulation surface 24 during such rotation of the visor body 12 between the various positions within its range of motion, including, for example, during deployment, stowing, and adjustment of the visor body 12 among such various positions. In this manner, the first articulation 14 surface is configured to slide over the second articulation surface 24 to facilitate such rotation of the visor body 12, with the axis of rotation R of the visor body being defined within the first articulation surface 14 and by the engagement of a supporting rod 32 with the visor body 12 generally opposite the first articulation surface 14, about which the visor body 12 is further configured to rotate.

In one implementation, the first magnetic element 16 and second magnetic element 26 can be configured such that the mutual attraction therebetween results in the second articulation surface 24 being retained against the first articulation surface 14 at a force of between 30 N and 40 N. In a further implementation the retention force between the second articulation surface 24 being retained against the first articulation surface 14 can be approximately 34 N (+/−5%). It is to be appreciated that a number of factors can influence the retention force characterized above, including but not limited to, the strength of the first magnetic element 16, the magnetic characteristic of the second magnetic element 26 (including whether the second magnetic element 26 is a magnet and its strength or if the second magnetic element 26 is simply magnetically active and the specific size and composition thereof), the thickness of the mounting block 18 (and its composition), and the thickness of the body defining the second articulation surface 24. The first articulation surface 14 and second articulation surface 24 can be configured to exhibit a mutual static coefficient of friction (μ) therebetween of between about 0.1 and 0.2 and in one implementation about 0.15 (+/−5%). The coefficient of friction can correspond with the retention force in that it is generally intended that the second articulation surface 24 be able to move relative to the first articulation surface 14 (by rotation of the visor body 12, as discussed above) without rolling or other longitudinal movement (i.e., translation) under normal conditions. In this respect, in one implementations, the first articulation surface 14 and the second articulation surface 24 can be defined on bodies comprised of plastic, such as polycarbonate or acrylonitrile butadiene styrene (“ABS”), mixtures thereof, or other plastics, having a smooth finish or surface quality.

To position the axis of rotation R in a desired location with respect to the mounting block 18, the visor body 12, which defines opposite first and second major faces 34, 36 and an upper edge 38 extending between the first and second major faces 34, 36, the first articulation surface 14 can be defined as a partially cylindrical segment 40 extending along a portion of the upper edge 38. The first magnetic element 16 can be received within the partially cylindrical segment 40, in one implementation, by being configured as a cylinder itself. In one aspect, the visor body 12 is configured to align the partially cylindrical segment 40 with the supporting rod 32 and can, further, have a similar (or at least approximately the same) diameter thereof. In this arrangement, the mounting block 18 can include a housing 42 defining the second articulation surface 24 by way of a concave portion 44 having a rounded profile extending across the housing 42. As can be appreciated, the rounded profile of the concave portion 44 is configured to match the outer profile of the cylindrical segment 40 such that the cylindrical segment 40 nests within the concave portion 44. As shown in FIGS. 7 and 8, the concave portion 44 extends only partially around the cylindrical segment 40, such as about 450 around the cylindrical segment 40. As discussed further below, the arc length of the concave portion 44, which appreciably varies with the size of the cylindrical segment 40, is configured to be sufficient to maintain the nested, articulating arrangement of the cylindrical segment 40 within the concave portion 44, including against the static and moving friction between the articulation surfaces 14 and 24 under the attraction force between the first and second magnets 16 and 26, while allowing for the intentional release of the cylindrical segment 40 from the concave portion 44 by the application of a force against the visor body 12 directed within a range of radial directions with respect to the axis of rotation R.

In one respect, as shown in FIG. 7, the mounting block 18 can be configured to release by application of a force above the breakover threshold, mentioned above, in a direction away from the windshield 30 along a rotational path P toward the adjacent side window 46 of the vehicle 20. In this respect, as is common among automotive visors in general, the pivot mount 28 is further configured to allow the visor body 12 to rotate laterally outward so as to extend along the side window 46 to afford use of the visor body 12 to shade the upper portion of the side window 46, when needed. To facilitate such movement, the supporting rod 32 is pivotably engaged with the pivot mount 28. As can be appreciated, this type of movement is typically provided in an automotive visor by the side opposite a mount similar to pivot mount 28 being supported by a clip that receives a rod portion of the visor. In such an arrangement, the clip has an open side that faces away from the windshield 30 such that the user can grasp the visor and pull the visor away from the windshield 30 to release the rod portion from the clip. In this manner, the present visor assembly 10 uses the above-described attraction between the first magnetic element 16 and the second magnetic element 26 in replacement of such a clip. Accordingly, in one example the breakaway threshold above which the visor body 12 releases from the mounting block 18 is configured to mimic the release force of a typical clip arrangement, at least in a range or force application from away from the windshield 30 to a direction away from the headliner 22, as discussed further below. As can be appreciated the automotive visor assembly 10 depicted herein is configured for use on a driver side of the vehicle 20, with a passenger-side visor assembly 10 being generally configured as a mirror image of the depicted automotive visor assembly 10.

In one aspect, the present visor body 12 includes an electrochromic element 48 coupled with and, accordingly, retained by a mounting structure 50. This arrangement is described further in co-pending, commonly assigned U.S. Pat. App. No. 63/602,165, the entire disclosure of which is incorporated by reference herein. In this manner, the electrochromic element 48 rotates with the rotation of the visor body 12, overall, as discussed above. An example of the structure of the electrochromic element 48 is discussed in further detail in the above-referenced Application 63/602,165, but it is to be generally appreciated that the electrochromic element 48 is configured so as to exhibit a controllable level of light transmission therethrough. In various examples, the transmission can be from near full transmission (e.g., about 95% or more) to zero light transmission (i.e., fully opaque), depending on the application of an electrical current or potential thereto. In this manner, the incorporation of the electrochromic element 48 allows for the portion of the visor body 12 that comprises the electrochromic element 48 to impart a level of selective transmissiveness to the visor body 12 such that direct light, for example, can be reduced to a comfortable level without obstructing the view through the portion of the windshield 30 that the electrochromic element 48 overlies (so long as some level of transmission remains within the electrochromic element 48). In a variation of the visor body 12, the electrochromic element 48 can be replaced by an electronically-controlled switchable mirror element, such as that which is described in co-pending, commonly-assigned U.S. Pat. App. No. 63/618,540, the entire disclosure of which is also incorporated by reference herein.

As further shown in FIGS. 7 and 8, the above-described mounting structure 50 includes a first frame member 52 and second frame member 54 that cooperatively retain at least a portion of the electrochromic element 48. As shown, in the first and second frame members 52, 54 can be internal components of the visor body 12 such that they are enclosed within first and second cover members 56 and 58 that can extend over the first and second frame members 52 and 54 to provide a desired cosmetic appearance. In one aspect, the first magnetic element 16 can be attached with one or both of the first and second frame members 52, 54. In such a configuration, the first and second cover members 56 and 58 can collectively define the cylindrical segment 40 and, accordingly, the first articulation surface 14 by enclosing and at least partially surrounding the first magnetic element 16. In this respect, the cylindrical segment 40 can be defined within an indented portion 59 of the visor body 12 that is sufficient to allow for the desired range of movement of the visor body 12, as discussed above, when the first and second articulation surfaces 14, 24 are mutually engaged. Because of the magnetic attachment described herein, the cylindrical segment 40 does not have to extend entirely around the first magnetic element 16 and, accordingly, does not require a full cutout therearound, as is common in clip-based automotive visor mounting arrangements.

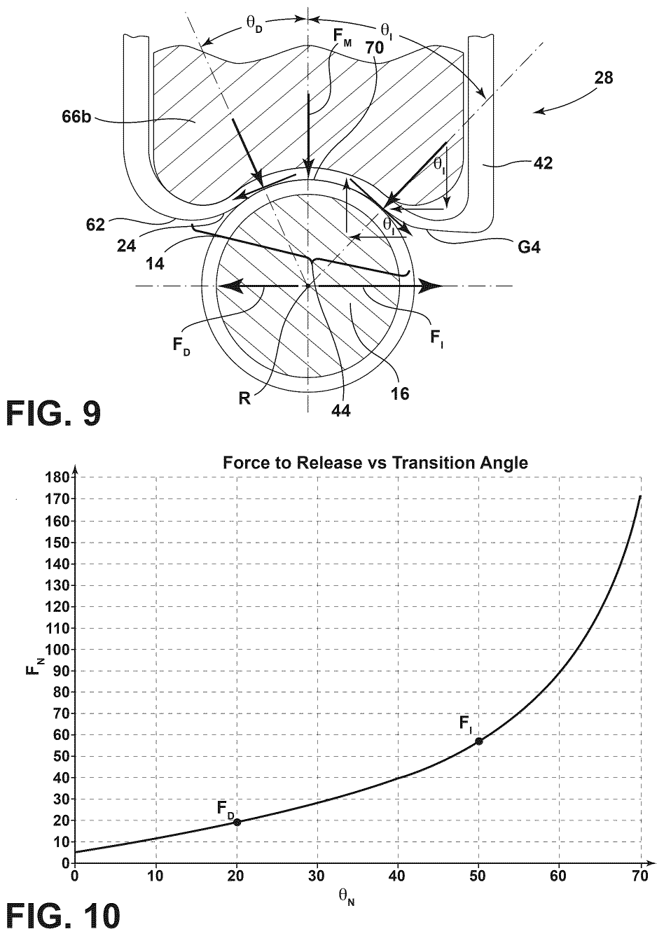

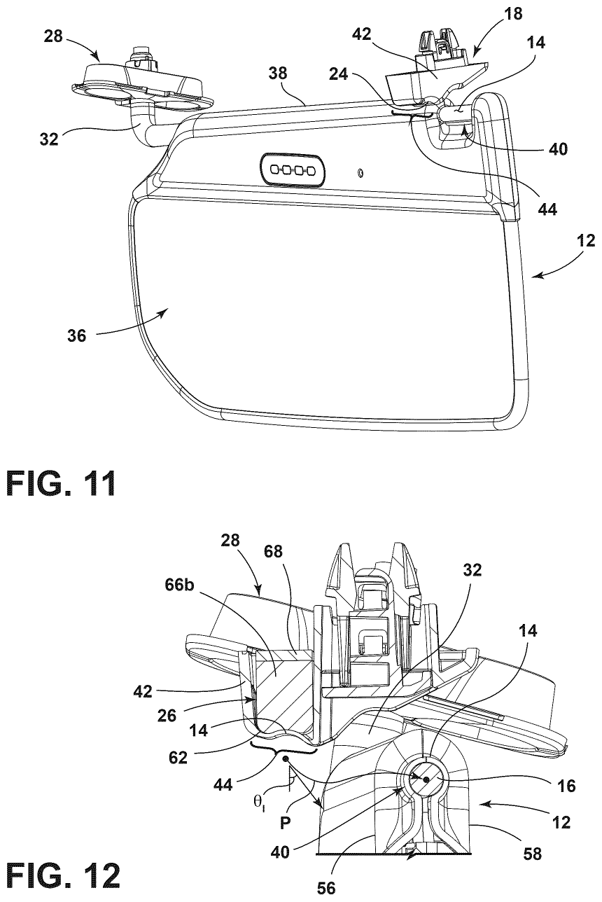

As discussed above, the visor body 12 is detachable from the mounting block 18 at the first articulating surface 14 by a force above the above-described breakaway force. In a further aspect, the breakaway force can be less than a fracture force of the electrochromic element 48. In this respect, the threshold for such breakaway force can allow the visor body 12 to move toward the windshield 30 under the application of a force against the visor body 12, such as by way of the impact of an object from within the vehicle 20 moving toward the visor body 12 when deployed, to prevent breakage of the electrochromic element 48 by way of the impact. An example of the release of the visor body 12 from the mounting block 18 and movement into a released position toward the windshield 30 is shown in FIGS. 11 and 12. In a particular aspect, it may be desired to have the breakaway force be less than the fracture force of the electrochromic element 48 by an appreciable degree, such as to allow for relatively easier movement of the visor body 12 into the rotated position of FIG. 6. In a similar aspect, it may be desired to increase the force needed to move the visor body 12 toward the windshield 30 to avoid inadvertent movement as such. Accordingly, as shown in the drawings and, in particular, in FIG. 9, the second articulation surface 24 can be defined with the above-described rounded profile extending to a leading edge 62 and a trailing edge 64. The trailing edge 64 can be configured to be spaced at a distance from the headliner 22 that is greater than a distance at which the leading edge 62 is spaced, such that the second articulation surface 24 is canted away from the windshield 30.

As shown in FIG. 8, the positioning and arrangement of the second articulation surface 24 can be such that the initial movement of the first articulating surface 14, with respect to the second articulating surface 24 on the application of a force applied in a horizontal direction normal to the magnetic force FM that extends through the apex 70 of the second articulation surface 24 is at an angle relative to the application of such force. More specifically, a force F_{D} applied horizontally in a direction away from the windshield 30 results in the cylindrical segment 40 moving at a deployment transition angle θ_{D} that corresponds with a tangent to the center of an area of contact between the first articulation surface 14 and the second articulation surface 24 during such initial movement. In the illustrated implementation, the deployment transition angle θ_{D} is about 200 (+/−5%) and in one implementation may be 20°. As further shown, the above-described arrangement wherein the leading edge 62 of the second articulation surface 24 is positioned vertically below the trailing edge 64 can increase the force needed to move the visor body 12 in the forward direction by requiring movement over the trailing edge 64 along the path P shown in FIG. 10. Further, this geometry results in an impact transition angle θ_{I} being greater than the deployment transition angle θ_{D}. Similar to the deployment transition angle θ_{D}, the impact transition angle θ_{I} corresponds with a tangent of a center of contact between the first articulation surface 14 and the second articulation surface 24 under a horizontally applied impact force F_{I} directed toward the windshield 30. In the present implementation, the impact transition angle θ_{I} is about 500 (+/−5%) and in one implementation may be 20°.

In the present configuration, a horizontal force F_{N} required to release the visor body 12 (at the cylindrical segment 40) from the mounting block 18 (i.e., by overcoming the attractive force between the first magnetic element 16 and the second magnetic element 26), as a function of the transition angle θ_{N} can be determined by the following equation:

$${F}_{N} = \frac{{F}_{M}}{( cos ( {θ}_{N} ) - μ \cdot sin ( {θ}_{N} ) )} , \qquad ( 1 )$$

where:
   θ_{N} is equal to the transition angle (between 0.1° and 70°);
   F_{M} is equal to the effective magnetic force between the first magnetic element 16 and the second magnetic element 26 at a direction normal to the apex 70; and
   μ is equal to the static sliding coefficient of friction between the first articulation surface 14 and the second articulation surface 24.

The results of equation (1) in the implementation of the structure described herein (where, F_{M} and μ are constants with values of 35 N and 0.15, as discussed above, are shown in FIG. 9. In the present implementation, wherein the transition angle θ_{N} is different on either side of the apex 70, as realized by horizontal force application in opposite directions, the resulting magnitude of the force for deployment F_{D} (away from windshield 30) and release on impact F_{I} (toward windshield 30) will vary. In particular, the above-described deployment transition angle θ_{D} being about 200 results in the deployment force FD for release of the visor body 12 at the cylindrical segment 40 from the mounting block 18 being about 20 N, and in a more specific implementation, about 19 N (all values+/−5%). As can be appreciated, the configuration of the deployment transition angle θ_{D} being below 450 results in the deployment force FD being lower than the effective magnetic force FM. In a similar manner, the above-described impact transition angle θ_{I} being about 500 results in the deployment force FD for release of the visor body 12 at the cylindrical segment 40 from the mounting block 18 being about 60 N, and in a more specific implementation, about 57 N (all values+/−5%). As can be appreciated, the configuration of the deployment transition angle θ_{I} being above 450 results in the deployment force FD being greater than the effective magnetic force F_{M}. According to the principles discussed herein, the specific geometry of the first transition surface, particularly, the relative positioning of the leading edge 62 relative to the trailing edge 64 may be adjusted to achieve different transition angles θ_{D} and θ_{I} to adjust the relative release forces F_{D} and F_{I}. Similarly, the first magnetic element 16 and the second magnetic element 26 can be configured to influence the magnetic force FM to achieve results that vary from those discussed above, according to various needs for implementations of the visor assembly 10 according to the principles discussed herein, and to accommodate for various additional factors. It is also appreciated that the actual force application on the visor body 12 may not be exactly horizontal, during real-world conditions and use, and that the amount of force needed to overcome the magnetic force F_{M} and, accordingly, to release the visor body 12 from the mounting block 18 at the cylindrical segment 40 is understood as corresponding with the above-described breakaway force. In this manner, it is to be understood that the breakaway force may vary with the specific instantaneous direction of application, including but not limited to the directions of the deployment force F_{D} and impact force F_{I} described herein. The breakaway force, accordingly, may also vary, with the above description generally characterizing the factors influencing the configuration of the various components.

As further shown, in FIGS. 7-12, the second magnetic element 26, including the magnets 66a and 66b, discussed above in the present implementation of the present visor assembly 10, can be configured to follow the general shape of the of the first articulating surface 14. In this respect the magnets 66a, 66b can have a concave lower face 76 that is configured to receive the portion of the mounting block 18 on which the second articulation surface 24 is applied. This configuration helps maintain the above-described magnetic force FM during the initial movement of the visor body 12 by either the depicted deployment force FD or the impact force FI, thus, helping to achieve the values for such forces discussed above.

In general, the breakaway force can be calibrated or otherwise configured by the form and composition of the first and second magnetic elements 16 and 26. In one aspect, the first magnetic element 16 can be a steel rod segment that is attracted to a magnet but is not itself magnetized. In connection with such an implementation of the first magnetic element 16, the second magnetic element 26 can comprise at least one magnet. In the present example, the second magnetic element 26 comprises two magnets 66a and 66b joined by a steel plate 68. In one implementation, the magnets 66a and 66b can be neodymium magnets.

In a further aspect, the automotive visor can further include a position sensor (e.g., as a component of a printed circuit board (“PCB”) 60—FIG. 8) that can allow the electronic circuitry to determine whether the visor body 12 is in a deployed position. This determination can allow the electronic circuitry to deactivate the electrochromic element 48 when the visor is in the stowed position to, for example, reduce power consumption or the like. In such an arrangement, the position sensor can be a hall-effect sensor that can be used to determine the position of the visor body 12 based on the position or orientation of the magnetic field of the magnets 66a, 66b with respect to, for example, the PCB 60.

The invention disclosed herein is further summarized in the following paragraphs and is further characterized by combinations of any and all of the various aspects described therein.

According to another aspect of the present disclosure, an automotive visor includes a visor body including a first articulation surface and a first magnetic element disposed within the articulation surface and a mounting block configured to attach to a vehicle along a portion of a headliner. The mounting block defines a second articulating portion and includes a second magnetic element disposed adjacent to the second articulation surface. The first and second magnets are mutually attracted to each other to maintain an articulating contact between the first articulation surface and the second articulation surface under a load below a breakaway threshold.

In the automotive visor of ¶ [0031], the visor body can define opposite first and second major faces and an upper edge extending between the first and second major faces, the first articulation surface can be defined as a partially cylindrical segment extending along a portion of the upper edge, and the first magnetic element can be received within the partially cylindrical segment.

In the automotive visor of ¶ [0031] or [0032], the mounting block can include a housing defining the second articulation surface by way of a concave portion having a rounded profile extending across a portion of the housing, the rounded profile extending to a leading edge and a trailing edge the trailing edge configured to be spaced at a distance from the headliner that is greater than a distance at which the leading edge is spaced, and the second magnetic element can be received in the housing.

In the automotive visor of any one of ¶ [0031] to [0033], the breakaway threshold can be configured to maintain the first articulating surface in contact with the second articulating surface during rotation of the visor body between a deployed position.

In the automotive visor of any one of ¶ [0031] to [0034], the visor body can include an electrochromic element defining a planar width and height and a mounting structure coupled with the electrochromic element along a first side of a perimeter thereof, and the first articulation surface can be defined on the mounting structure.

It will be understood by one having ordinary skill in the art that construction of the described disclosure and other components is not limited to any specific material. Other exemplary embodiments of the disclosure disclosed herein may be formed from a wide variety of materials, unless described otherwise herein.

It is also important to note that the construction and arrangement of the elements of the disclosure as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

The above description is considered that of the preferred embodiments only. Modifications of the invention will occur to those skilled in the art and to those who make or use the invention. Therefore, it is understood that the embodiments shown in the drawings and described above are merely for illustrative purposes and not intended to limit the scope of the invention, which is defined by the claims as interpreted according to the principles of patent law, including the doctrine of equivalents.

What is claimed is:

1. An automotive visor, comprising:
a visor body including a first articulation surface and a first magnetic element disposed within the articulation surface; and
a mounting block configured to attach to a vehicle along a portion of a headliner, the mounting block defining a second articulation surface and including a second magnetic element disposed adjacent to the second articulation surface, the first and second magnetic elements being mutually attracted to each other to maintain an articulating contact between the first articulation surface and the second articulation surface under a force applied to the visor body below a breakaway threshold.

2. The automotive visor of claim 1, wherein:
the visor body defines opposite first and second major faces and an upper edge extending between the first and second major faces;
the first articulation surface is defined as a partially cylindrical segment extending along a portion of the upper edge; and
the first magnetic element is received within the partially cylindrical segment.

3. The automotive visor of claim 1, wherein:
the mounting block includes a housing defining the second articulation surface by way of a concave portion having a rounded profile extending across a portion of the housing, the rounded profile extending to a leading edge and a trailing edge the trailing edge configured to be spaced at a distance from the headliner that is greater than a distance at which the leading edge is spaced; and
the second magnetic element is received in the housing.

4. The automotive visor of claim 1, wherein the breakaway threshold is configured to maintain the first articulating surface in contact with the second articulating surface during rotation of the visor body between a deployed position and at least one of a plurality of use positions.

5. The automotive visor of claim 4, wherein the second articulation surface is configured such that the breakaway threshold varies with a direction of the force applied to the visor body.

6. The automotive visor of claim 5, wherein the second articulation surface is configured with a leading edge and a trailing edge, the leading edge being positionable closer to a vehicle windshield than the trailing edge and being positioned vertically below the trailing edge such that the breakaway threshold corresponding with an impact force on the visor body directed horizontally toward the windshield is greater than the breakaway threshold corresponding with a deployment force directed horizontally away from the windshield.

7. The automotive visor of claim 6, wherein the leading edge being positioned vertically below the trailing edge is such that the second articulation surface defines:
an impact transition angle between the first articulation surface and the second articulation surface of about 50°; and
a deployment transition angle between the first articulation surface and the second articulation surface of about 20°.

8. The automotive visor of claim 6, wherein:
the breakaway threshold corresponding with the impact force on the visor body directed horizontally toward the windshield is between 55 N and 65 N; and
the breakaway threshold corresponding with the deployment force directed horizontally away from the windshield is between 18 N and 30 N.

9. The automotive visor of claim 6, wherein the breakaway threshold corresponding with a release force on the visor body in a direction vertically away from an apex of the second articulation surface is about 35 N.

10. The automotive visor of claim 6, wherein the leading edge is about 2 mm below the trailing edge.

11. The automotive visor of claim 1, wherein the visor body includes an electrochromic element defining a planar width and height.

12. The automotive visor of claim 11, wherein the second articulation surface is configured such that the breakaway threshold corresponding with an impact force on the visor body directed horizontally toward a vehicle windshield is less than a fracture force of the electrochromic element.

13. The automotive visor of claim 11, further including a controller configured for applying a voltage to the electrochromic element corresponding with a state of transmissiveness of the electrochromic element and a position sensor disposed within the visor body, wherein:
the position sensor is in communication with the controller; and
the controller uses position information from the position sensor to control at least one operational characteristic of the electrochromic element, including the state of transmissiveness.

14. An automotive visor, comprising:
a visor body including a first articulation surface and a first magnetic element disposed within the articulation surface; and
a mounting block configured to attach to a vehicle along a portion of a headliner, the mounting block defining a second articulation surface, a leading edge, and a trailing edge, the leading edge being positionable closer to a vehicle windshield than the trailing edge and being positioned vertically below the trailing edge, the mounting block further including a second magnetic element disposed adjacent to the second articulation surface, the first and second magnetic elements being mutually attracted to each other to maintain an articulating contact between the first articulation surface and the second articulation surface under a force applied to the visor body below a breakaway threshold that varies with a direction of the force applied to the visor body;
wherein the breakaway threshold corresponding with an impact force on the visor body directed horizontally toward the windshield is greater than the breakaway force corresponding with a deployment force directed horizontally away from the windshield.

15. The automotive visor of claim 14, wherein the leading edge being positioned vertically below the trailing edge is such that the second articulating surface defines:
an impact transition angle between the first articulation surface and the second articulation surface of about 50°; and
a deployment transition angle between the first articulation surface and the second articulation surface of about 20°.

16. The automotive visor of claim 14, wherein:
the breakaway force corresponding with the impact force on the visor body directed horizontally toward the windshield is between 55 N and 65 N; and
the breakaway force corresponding with the deployment force directed horizontally away from the windshield is between 18 N and 30 N.

17. The automotive visor of claim 14, wherein the breakaway threshold corresponding with a release force on the visor body in a direction vertically away from an apex of the second articulation surface is about 35 N.

18. The automotive visor of claim 14, wherein the visor body includes an electrochromic element defining a planar width and height.

19. The automotive visor of claim 18, wherein the second articulation surface is configured such that the breakaway threshold corresponding with an impact force on the visor body directed horizontally toward a vehicle windshield is less than a fracture force of the electrochromic element.

20. An automotive visor system for a vehicle having a windshield, comprising:
a visor body including a first articulation surface and a first magnetic element disposed within the articulation surface; and
a mounting block configured to attach to a vehicle along a portion of a headliner, the mounting block defining a second articulation surface and including a second magnetic element disposed adjacent to the second articulation surface, the first and second magnetic elements being mutually attracted to each other to maintain an articulating contact between the first articulation surface and the second articulation surface under a force applied to the visor body below a breakaway threshold, the breakaway threshold being configured to maintain the first articulating surface in contact with the second articulating surface during rotation of the visor body between a deployed position and at least one of a plurality of use positions;
a position sensor mounted within the visor body and detecting a magnetic field associated with the second magnetic element;
an electrochromic element configurable between a plurality of transmissiveness states responsive to a voltage application; and
a controller configured for applying the voltage to the electrochromic element and being in communication with the position sensor, the controller using position information from the position sensor to control at least one operational characteristic of the electrochromic element, including the state of transmissiveness.
